(19) United States
(12) Patent Application Publication
(10) Pub. No.: US 2025/0246029 A1
(43) Pub. Date: Jul. 31, 2025

(54) VEHICLE CONTROL SYSTEM

(71) Applicant: TOYOTA JIDOSHA KABUSHIKI KAISHA, Toyota-shi (JP)

(72) Inventor: Masaki MIYAKE, Toyota-shi (JP)

(73) Assignee: TOYOTA JIDOSHA KABUSHIKI KAISHA, Toyota-shi (JP)

(21) Appl. No.: 19/013,250

(22) Filed: Jan. 8, 2025

(30) Foreign Application Priority Data
Jan. 25, 2024 (JP) 2024-009343

(51) Int. Cl. G07C 5/00

(52) U.S. Cl. CPC G07C 5/008

(57) ABSTRACT

A vehicle control system includes multiple function-specific ECUs each having a memory and a CPU. Each of the function-specific ECUs transmits version information related to the version of its own software. When receiving the version information transmitted from other function-specific ECUs, at least one function-specific ECU determines which of multiple functions is executable based on the version of its own software and the version indicated by the version information. The at least one function-specific ECU permits execution of the function determined to be executable among the multiple functions, and prohibits the execution of the function determined not to be executable.

### CROSS-REFERENCE TO RELATED APPLICATIONS

This application is based upon and claims the benefit of priority from Japanese Patent Application No. 2024-009343, filed on Jan. 25, 2024, the entire contents of which are incorporated herein by reference.

### BACKGROUND

### 1. Field

The present disclosure relates to a vehicle control system including multiple electronic control units.

### 2. Description of Related Art

Japanese Laid-Open Patent Publication No. 2019-159399 discloses a vehicle control system including multiple electronic control units. Each of the electronic control units includes a CPU and a memory that stores software executed by the CPU. In the vehicle control system, when the software versions of the electronic control units are compatible with each other, the execution of multiple functions related to various types of driving of the vehicle, such as autonomous driving, is permitted. On the other hand, when the software versions of the electronic control units are not compatible with each other, the execution of the above multiple functions is prohibited.

In the above system, when the software versions of the electronic control units are not compatible with each other, the execution of the above multiple functions is uniformly prohibited.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a vehicle control system includes multiple electronic control units that store software for executing multiple functions related to driving of a vehicle. Each of the electronic control units includes a circuit that transmits version information related to a version of software stored in that electronic control unit. The circuit of at least one of the electronic control units is configured to receive the version information transmitted from other electronic control units. The circuit of at least one of the electronic control units is also configured to, when version information transmitted from other electronic control units is received, determine which of the multiple functions is executable, based on the version of the software stored within the electronic control unit itself and the version indicated by the received version information. The circuit of at least one of the electronic control units is further configured to permit execution of the function determined to be executable among the multiple functions, while prohibiting execution of the function determined not to be executable.

Other features and aspects will be apparent from the following detailed description, the drawings, and the claims.

### BRIEF DESCRIPTION OF THE DRAWINGS

FIG. 1 is a diagram showing the configuration of a vehicle including a vehicle control system according to an embodiment and a server capable of communicating with the vehicle.

FIG. 2 is a diagram showing an example of a correspondence table stored in a memory of an electronic control unit included in the vehicle control system shown in FIG. 1.

FIG. 3 is a sequence diagram showing a flow of a process for determining which of multiple functions is executable in the vehicle control system shown in FIG. 1.

FIG. 4 is a flowchart showing a series of processes executed by a CPU included in the electronic control unit in the vehicle control system shown in FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

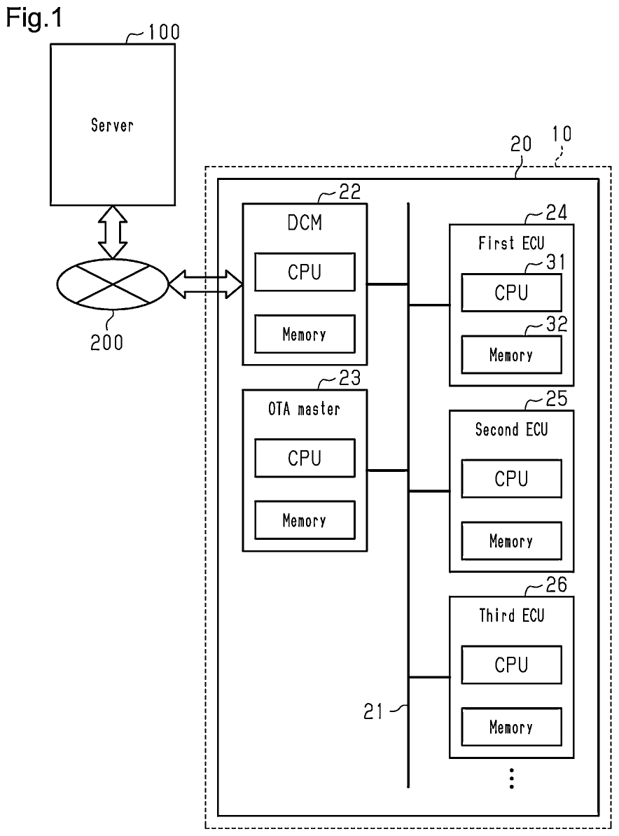

Hereinafter, an embodiment of a vehicle control system will be described with reference to FIGS. 1 to 4.

FIG. 1 shows a vehicle 10 and a server 100 installed outside the vehicle. The vehicle 10 includes a vehicle control system 20.

### Server

The server 100 is a server for management installed outside the vehicle 10. The server 100 manages software for multiple vehicles 10 registered in advance. The server 100 transmits and receives various kinds of information to and from the vehicle 10 via the vehicle external network 200. The vehicle external network 200 is a wireless communication network. For example, the server 100 transmits the update software for the vehicle 10 to the vehicle 10 in response to a request from the vehicle 10.

### Vehicle Control System

The vehicle control system 20 includes multiple electronic control units (ECUs) configured to transmit and receive information to and from each other via an in-vehicle network 21. The ECUs include a data communication module (DCM) 22 and an over-the-air (OTA) master 23. The DCM 22 is a communication module that communicates with the server 100 via the vehicle external network 200. The OTA master 23 manages software of the ECUs including itself.

The ECUs further include multiple function-specific ECUs 24, 25, 26. For example, the function-specific ECUs include the following ECUs, for example:
an ADAS ECU that collects information for supporting the driving operation of the driver of the vehicle 10;
an ECU that controls a power source of the vehicle 10 such as an engine or a travel motor;
an ECU that controls a braking device of the vehicle 10; and
an ECU that controls an actuator for adjusting steering of a wheel of a vehicle 10.

Each of the DCM 22, the OTA master 23, and the function-specific ECUs 24, 25, 26 includes a CPU 31 and a memory 32. The memory 32 stores software to be executed by the CPU 31. The function-specific ECUs 24, 25, 26 can execute multiple functions related to traveling of the vehicle 10 by the CPU 31 executing the software of the memory 32. Examples of the multiple functions include a function of autonomous driving, a function of automatic braking for collision prevention, lane keep assist, and adaptive cruise control. The autonomous driving function may include at least one of an autonomous driving function of autonomous driving level 2, an autonomous driving function of autonomous driving level 3, an autonomous driving function of autonomous driving level 4, and an autonomous driving function of autonomous driving level 5.

The software stored in the memories 32 of the function-specific ECUs 24, 25, 26 is appropriately rewritten with the update software transmitted from the server 100. That is, in the function-specific ECUs 24, 25, 26, version-up of software is appropriately performed.

The multiple functions described above can be executed by multiple function-specific ECUs cooperating with each other. At this time, in a case where the versions of the software of the function-specific ECUs are not consistent with each other, at least a part of the multiple functions may not be executed.

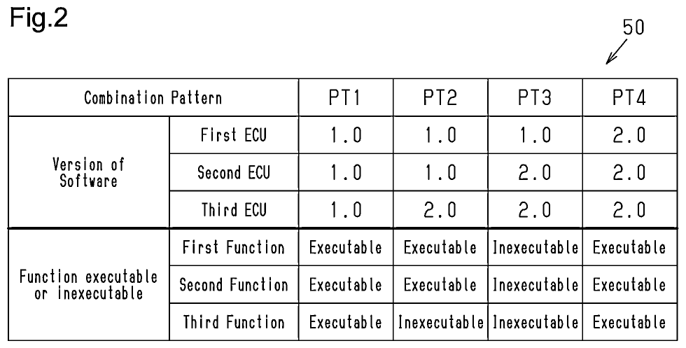

Therefore, a correspondence table 50 as shown in FIG. 2 is stored in each of the memories 32 of the function-specific ECUs 24, 25, 26. When the software is updated in at least one function-specific ECU of the function-specific ECUs 24, 25, 26, the correspondence table 50 of the memory 32 is also updated in the function-specific ECUs 24, 25, 26.

In the following description, for convenience of understanding of the specification, it is assumed that the number of function-specific ECUs is three, that is, a first ECU 24, a second ECU 25, and a third ECU 26, and the number of functions is three.

In order to execute the first function of the three functions, the first ECU 24 and the second ECU 25 of the three function-specific ECUs 24, 25, 26 are necessary, while the third ECU 26 is unnecessary. In order to execute the second function and the third function among the three functions, all of the three function-specific ECUs 24, 25, 26 are necessary.

In FIG. 2, four patterns PT1, PT2, PT3, and PT4 are shown as the combination patterns of the versions of the software.

In the pattern PT1, the software version is 1.0 in any of the first ECU 24, the second ECU 25, and the third ECU 26. In the case of the pattern PT1, any of the first function, the second function, and the third function can be executed.

That is, in a case where the version of the software is 1.0 in both the first ECU 24 and the second ECU 25, it can be determined that the version of the software of the first ECU 24 and the version of the software of the second ECU 25 are compatible with each other in that the first function is executed. In addition, in a case where the version of the software is 1.0 in any of the three function-specific ECUs 24, 25, 26, it is possible to determine that the versions of the software of the three function-specific ECUs 24, 25, 26 are compatible with each other in that the second function and the third function are executed.

In the pattern PT2, the software versions of the first ECU 24 and the second ECU 25 are 1.0, and the software version of the third ECU 26 is 2.0. In the case of the pattern PT2, the first function and the second function can be executed, but the third function cannot be executed.

That is, when the version of the software of the first ECU 24 and the second ECU 25 is 1.0 and the version of the software of the third ECU 26 is 2.0, it can be determined that the versions of the software of the three function-specific ECUs 24 25 and 26 are compatible with each other in that the second function is executed. On the other hand, in terms of executing the third function, it can be determined that the the versions of the software of the three function-specific ECUs 24, 25, 26 are not compatible with each other.

In the pattern PT3, the software version of the first ECU 24 is 1.0, and the software versions of the second ECU 25 and the third ECU 26 are 2.0. In the case of the pattern PT3, execution is not possible in any of the first, second, and third functions.

That is, in a case where the version of the software of the first ECU 24 is 1.0 and the version of the software of the second ECU 25 is 2.0, it can be determined that the version of the software of the first ECU 24 and the version of the software of the second ECU 25 are not compatible with each other in that the first function is executed. In a case where the version of the software of the first ECU 24 is 1.0 and the version of the software of the second ECU 25 and the third ECU 26 is 2.0, it can be determined that the versions of the software of the three function-specific ECUs 24, 25, 26 are not compatible with each other in that the second function and the third function are executed.

In the pattern PT4, the software version is 2.0 in any of the first ECU 24, the second ECU 25, and the third ECU 26. In the case of the pattern PT4, any of the first function, the second function, and the third function can be executed.

That is, in a case where the version of the software is 2.0 in both the first ECU 24 and the second ECU 25, it can be determined that the version of the software of the first ECU 24 and the version of the software of the second ECU 25 are not compatible with each other in that the first function is executed. In addition, in a case where the version of the software is 2.0 in any of the three function-specific ECUs 24, 25, 26, it is possible to determine that the versions of the software of the three function-specific ECUs 24, 25, 26 are compatible with each other in that the second function and the third function are executed.

Flow of Process when Execution of Function is Permitted or Prohibited

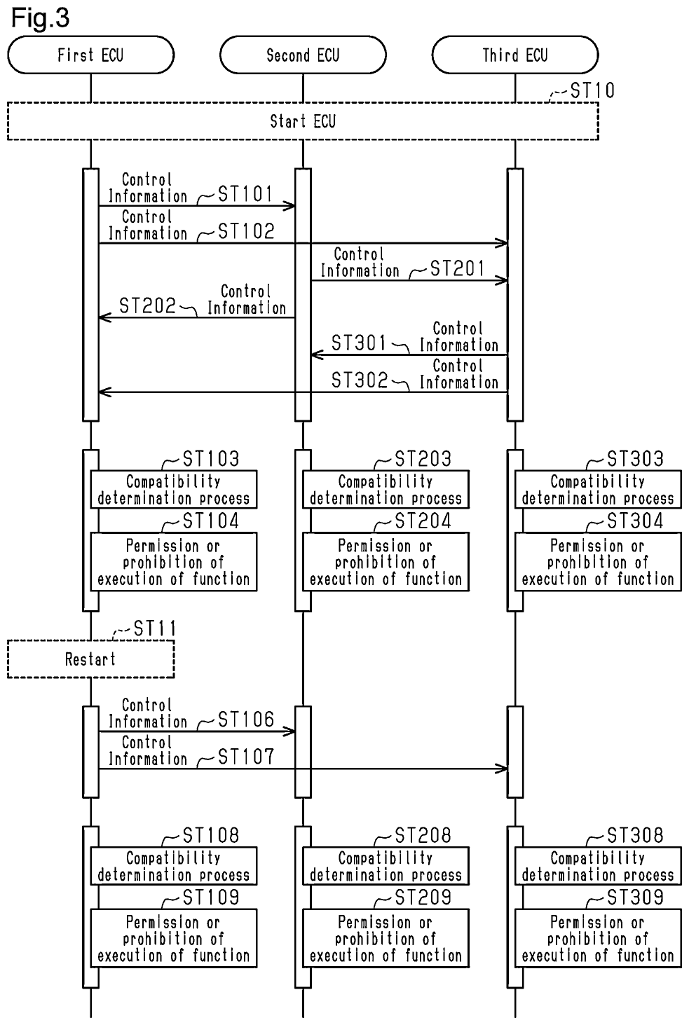

A flow of processes in the entire vehicle control system 20 when the execution of a function is permitted or prohibited will be described with reference to FIG. 3.

First, when the power supply system in the vehicle 10 is turned on, the function-specific ECUs 24, 25, 26 are activated (ST10). Then, the function-specific ECUs 24, 25, 26 transmit their own control information to the other ECUs via the in-vehicle network 21. The control information includes version information which is information related to the version of the software stored in the memory 32 of its own. In the present example, the control information transmitted by the first ECU 24 in step ST101 is received by the second ECU 25. In step ST102, the control information transmitted by the first ECU 24 is received by the third ECU 26. In step ST201, the control information transmitted by the second ECU 25 is received by the third ECU 26. In step ST202, the control information transmitted by the second ECU 25 is received by the first ECU 24. In step ST301, the control information transmitted by the third ECU 26 is received by the second ECU 25. In step ST302, the control information transmitted by the third ECU 26 is received by the first ECU 24.

When the transmission and reception of the control information is completed, each of the function-specific ECUs 24, 25, 26 proceeds to the next process.

In the first ECU 24, in step ST103, a matching determination process of determining whether software versions are compatible with each other is executed for each function. Then, in the first ECU 24, in the next step ST104, it is determined for each function whether execution of the function is permitted.

Similarly, in the second ECU 25, in step ST203, a compatibility determination process similar to that in step ST103 is executed. Then, in the second ECU 25, in the next step ST204, the same process as in the above step ST104 is executed.

Similarly, in the third ECU 26, in step ST303, a compatibility determination process similar to that in step ST103 is executed. Then, in the third ECU 26, in the next step ST304, the same process as in the above step ST104 is executed.

In the example shown in FIG. 3, after step ST104, the first ECU 24 acquires the software of the latest version transmitted from the server 100. When the first ECU 24 is not reset, in the first ECU 24, a state in which the CPU 31 executes software of a version older than the latest version is continued.

However, in a situation in which the vehicle control system 20 is operating, the first ECU 24 may be reset for some reason and the first ECU 24 may be restarted (ST11). In this case, in the first ECU 24, the CPU 31 executes the latest version of the software. Then, the first ECU 24 transmits its own control information to the other ECUs 25, 26 via the in-vehicle network 21. In other words, the control information transmitted by the first ECU 24 in step ST106 is received by the second ECU 25. In step ST107, the control information transmitted by the first ECU 24 is received by the third ECU 26.

When the transmission and reception of the control information is completed, each of the function-specific ECUs 24, 25, 26 advances to the next process.

In the first ECU 24, in step ST108, a compatibility determination process similar to that in step ST103 is executed. Then, in the first ECU 24, in the next step ST109, the same process as in the above step ST104 is executed.

Similarly, in the second ECU 25, in step ST208, a compatibility determination process similar to that in step ST203 is executed. Then, in the second ECU 25, in the next step ST209, the same process as in the above step ST204 is executed.

Similarly, in the third ECU 26, in step ST308, a compatibility determination process similar to that in step ST303 is executed. Then, in the third ECU 26, in the next step ST309, the same process as in the above step ST304 is executed.

### Process Content in Function-Specific ECUs

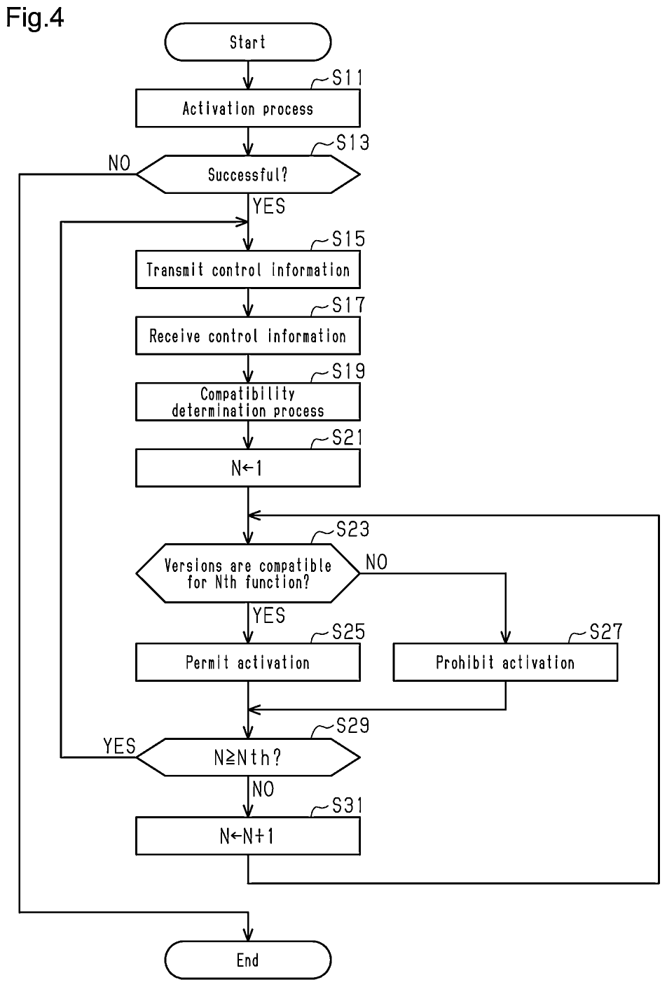

With reference to FIG. 4, a description will be given of a series of processes executed by the CPUs 31 of the function-specific ECUs 24, 25 and 26 in order to determine permission or prohibition of execution of multiple functions.

When supply of power to the function-specific ECUs 24, 25, 26 is started, the CPU 31 executes an activation process for activating the function-specific ECUs 24, 25, 26 in step S11. For example, in the activation process, the CPU 31 executes the software in the memory 32. When multiple pieces of software are stored in the memory 32, the CPU 31 executes the software of the latest version.

In the following step S13, the CPU 31 determines whether the activation of the function-specific ECUs 24, 25, 26 has been successful. When determining that the activation is successful (S13: YES), the CPU 31 advances the process to step S15. On the other hand, when determining that the activation has not been successful (S13: NO), the CPU 31 ends the series of processes illustrated in FIG. 4.

In step S15, the CPU 31 transmits its own control information to other ECUs via the in-vehicle network 21. In this case, the other ECUs include the DCM 22 and OTA master 23 in addition to the other function-specific ECUs.

In the next step S17, the CPU 31 receives the control information transmitted by the other function-specific ECUs via the in-vehicle network 21.

In the subsequent step S19, the CPU 31 executes a compatibility determination process. For example, the CPU 31 executes the compatibility determination process using the correspondence table 50 illustrated in FIG. 2.

The compatibility determination process executed by the CPU 31 of the first ECU 24 will be described. In executing the first function, the CPU 31 determines whether the version of the software of the first ECU 24 and the version of the software of the second ECU 25 are compatible with each other. When executing the second function, the CPU 31 determines whether the versions of the software of the three function-specific ECUs 24, 25, 26 are compatible with each other. When executing the third function, the CPU 31 determines whether the versions of the software of the three function-specific ECUs 24, 25, 26 are compatible with each other.

After executing the compatibility determination process, the CPU 31 advances the process to step S21. In step S21, the CPU 31 sets a coefficient N to 1.

In the subsequent step S23, the CPU 31 determines whether the versions of the N-th function are compatible with each other based on the execution result of the compatibility determination process. When determining that the versions of the N-th function are compatible with each other (S23: YES), the CPU 31 advances the process to Step S25. In step S25, the CPU 31 permits execution of the N-th function. Then, the CPU 31 advances the process to step S29.

On the other hand, when determining that the versions of the N-th function are not compatible with each other in step S23 (S23: NO), the CPU 31 advances the process to step S27. In step S27, the CPU 31 prohibits execution of the N-th function. Then, the CPU 31 advances the process to step S29.

In step S29, the CPU 31 determines whether the coefficient N is greater than or equal to a number of functions Nth. The number of functions Nth is the total number of functions. In the present embodiment, the total number of functions is three. When the coefficient N is less than the number of functions Nth (S29: NO), the CPU 31 advances the process to step S31. In step S31, the CPU 31 updates the coefficient N so that the coefficient Nis increased by one. Then, the CPU 31 advances the process to step S23.

On the other hand, when the coefficient N is greater than or equal to the number of functions Nth in step S29 (S29: YES), the CPU 31 advances the process to step S15. That is, when the coefficient N is greater than or equal to the number of functions Nth, the CPU 31 can determine that the determination of whether the function is executable has been completed for all the functions.

### Operation and Advantages of Present Embodiment

Each of the function-specific ECUs 24, 25, 26 transmits version information related to the version of software stored therein to the in-vehicle network 21. Each of the function-specific ECUs 24, 25, 26 receives the version information transmitted from the other function-specific ECUs. Then, each of the function-specific ECUs 24, 25, 26 determines which of the multiple functions is executable based on the version of the software of its own memory 32 and the version indicated by the version information from the other function-specific ECUs. Each of the function-specific ECUs 24, 25, 26 permits the activation of the function determined to be executable among the multiple functions, and prohibits the activation of the function determined not to be executable.

Accordingly, in the vehicle control system 20, when the versions of the software of the function-specific ECUs 24, 25, 26 are not compatible with each other, the execution of the multiple functions is not uniformly prohibited. That is, the vehicle control system 20 prevents a situation in which none of the multiple functions can be executed from occurring.

While the vehicle control system 20 is operating as described above, for example, the first ECU 24 may acquire the latest version of software. In this case, when the first ECU 24 is reset thereafter and the first ECU 24 is restarted, the CPU 31 executes the software of the latest version in the first ECU 24. Then, version information indicating the latest version is transmitted from the first ECU 24 to the other function-specific ECUs 25, 26. In this case, the compatibility determination process is executed in each of the ECU 24 25 and 26. As a result, before the first ECU 24 is reset, execution of a function that has been executable may be prohibited. Further, before the first ECU 24 is reset, execution of a function that has been prohibited from being executed may be permitted.

### Modifications

The above-described embodiment may be changed as described below. The above-described embodiment and the following modifications can be combined as long as the combined modifications remain technically consistent with each other.

The number of function-specific ECUs may be any number other than three as long as it is two or more.

The vehicle control system 20 may be configured such that one of the function-specific ECUs functions as the OTA master.

Only some of the ECUs of the function-specific ECUs 24, 25, 26 may execute the following processes (A1), (A2), and (A3).

(A1) Version information transmitted from another function-specific ECU is received.

(A2) To determine which of multiple functions is executable based on a version of software stored in the own ECU and a version indicated by version information received from another function-specific ECU.

(A3) Among multiple functions, activation of a function determined to be executable is permitted, whereas activation of a function determined not to be executable is prohibited.

The ECU is not limited to an ECU that includes a CPU and a ROM and executes software processing. That is, the ECU may have any one of the following configurations (a)

(a) The ECU includes one or more processors that execute various processes in accordance with a computer program. Each processor includes a CPU and a memory, such as a RAM and a ROM. The memory stores program codes or instructions configured to cause the CPU to execute processes. The memory, which is a computer-readable medium, includes any type of media that are accessible by general-purpose computers and dedicated computers.

(b) The ECU includes one or more dedicated hardware circuits that execute various processes. The dedicated hardware circuits include, for example, an application specific integrated circuit (ASIC) and a field programmable gate array (FPGA). ASIC is an abbreviation of “Application Specific Integrated Circuit”, and FPGA is an abbreviation of “Field Programmable Gate Array”.

(c) The ECU includes one or more processors that execute part of various processes according to programs and one or more dedicated hardware circuits that execute the remaining processes.

The phrase “at least one of” as used in this description means “one or more” of a desired choice. As an example, the expression “at least one” as used herein means “only one option” or “both two options” if the number of options is two. As another example, the expression “at least one” used herein means “only one option” or “a combination of any two or more options” if the number of options is three or more.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A vehicle control system, comprising multiple electronic control units that store software for executing multiple functions related to driving of a vehicle, wherein
each of the electronic control units includes a circuit that transmits version information related to a version of software stored in that electronic control unit, and
the circuit of at least one of the electronic control units is configured to
receive the version information transmitted from other electronic control units,
when version information transmitted from other electronic control units is received, determine which of the multiple functions is executable, based on the version of the software stored within the electronic control unit itself and the version indicated by the received version information, and
permit execution of the function determined to be executable among the multiple functions, while prohibiting execution of the function determined not to be executable.

2. The vehicle control system according to claim 1, wherein
in order to execute a first function among the multiple functions, a first electronic control unit and a second electronic control unit among the electronic control units are required, but a third electronic control unit is not required, and
the circuit of the first electronic control unit and the circuit of the second electronic control unit are respectively configured to
receive the version information transmitted from other electronic control units, and
when the version information transmitted from the other electronic control units is received, determine that the first function is executable if the version of the software of the first electronic control unit and the version of the software of the second electronic control unit are compatible with each other, and determine that the first function is not executable if the versions of the software are not compatible with each other.

3. The vehicle control system according to claim 2, wherein
in order to execute a second function among the multiple functions, the first electronic control unit, the second electronic control unit, and the third electronic control unit among the electronic control units are required, and
the circuit of the first electronic control unit, the circuit of the second electronic control unit, and the circuit of the third electronic control unit are respectively configured to
receive the version information transmitted from other electronic control units, and
when the version information transmitted from the other electronic control units is received, determine that the second function is executable if the version of the software of the first electronic control unit, the version of the software of the second electronic control unit, and the version of the software of the third electronic control unit are compatible with each other, and determine that the second function is not executable if the versions of the software are not compatible with each other.
